(19) United States
(12) Patent Application Publication
(10) Pub. No.: US 2023/0074283 A1
(43) Pub. Date: Mar. 9, 2023

(54) SECURE PARCEL DELIVERY LOCKER AND DRONE DELIVERY SYSTEM

(71) Applicant: Alexander R. Malcolm, Cave Creek, AZ (US)

(72) Inventor: Alexander R. Malcolm, Cave Creek, AZ (US)

(21) Appl. No.: 17/891,660

(22) Filed: Aug. 19, 2022

Related U.S. Application Data
(60) Provisional application No. 63/241,080, filed on Sep. 6, 2021.

(51) Int. Cl. G06Q 10/08; G07C 9/00

(52) U.S. Cl. CPC G06Q 10/0836; G07C 9/00182

(57) ABSTRACT

A secure parcel delivery locker for the receipt of parcels that includes electronic mechanisms that actively assist drone deliveries by providing precise location information for use by drone delivery systems to drop off a parcel, aid in preventing theft thereof, and facilitate the recovery of a stolen parcel if theft does occur.

### CROSS-REFERENCE TO RELATED APPLICATION

There present application is related to and claims priority from prior provisional application Ser. No. 63/241,080, filed Sep. 6, 2021 which is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

### 1. Field of the Invention

This invention relates generally to parcel delivery lockers, and more specifically to parcel delivery lockers used in conjunction with an electronic delivery system.

### 2. Description of the Related Art

Home delivery of parcels has always been subject to victimization by thieves who steal parcels before the intended recipients can retrieve them. There have been many efforts to detect these thefts and many inventions to support this effort, most notably, video doorbells. But prior art video door bells don't prevent thefts. Some of the prior art inventions address stolen parcels if the parcel contains a trackable tag. There are also some prior art delivery lockers with electronic features, including video cameras and audible alarms. But, these products frequently require active participation by the delivery person to obtain a barcode and verification the code or keypad passcode to open the locker to make a delivery. All these things would slow down the delivery process and are unrealistic.

Furthermore, prior art package delivery systems have included drones that are equipped with GPS technology that can direct them to the delivery address, however, they do not allow them to find exactly where to position the drone for the delivery and the precise place on a property to drop off the parcel, i.e., front door, back door, side yard, etc., nor locate the exact geospatial spot to position the drone for the parcel delivery.

Accordingly, the present invention overcomes these disadvantages associated with the prior art, by providing a secure parcel delivery locker for the receipt of parcels that includes electronic mechanisms that actively assist drone deliveries by providing precise location information for use by drone delivery systems to drop off a parcel, aid in preventing theft thereof, and facilitate the recovery of a stolen parcel if theft does occur.

### BRIEF SUMMARY OF THE INVENTION

In view of the foregoing disadvantages inherent in the known types of parcel delivery lockers and drone delivery systems, or the like, in the prior art, the present invention provides a secure parcel delivery locker for the receipt of parcels that includes electronic mechanisms that actively assist drone deliveries. As such, the general purpose of the present invention, which will be described subsequently in greater detail, is to provide a secure parcel delivery locker for the receipt of parcels that includes electronic mechanisms that actively assist drone deliveries by providing precise location information for use by drone delivery systems to drop off a parcel, aid in preventing theft thereof, and facilitate the recovery of a stolen parcel if theft does occur, with all the advantages of the prior art and none of the disadvantages.

There has thus been outlined, rather broadly, the more important features of the invention in order that the detailed description thereof that follows may be better understood and in order that the present contribution to the art may be better appreciated.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. The invention is capable of other embodiments and of being practiced and carried out in various ways. Also, it is to be understood that the phraseology and terminology employed herein are for the purpose of descriptions and should not be regarded as limiting.

### BRIEF DESCRIPTION OF THE DRAWINGS

The figures which accompany the written portion of this specification illustrate embodiments according to the teachings of the present invention.

FIG. 1 shows a perspective view of the secure parcel delivery locker of the secure parcel delivery locker and drone delivery system according to the preferred embodiment of the present invention.

FIG. 2 shows a perspective view of a control unit for controlling the secure parcel delivery locker and drone delivery system according to the preferred embodiment of the present invention.

FIG. 3 shows a perspective view of the secure parcel delivery locker and drone delivery system according to the preferred embodiment of the present invention.

The various embodiments of the present invention will hereinafter be described in conjunction with the appended drawings.

### DETAILED DESCRIPTION

The embodiments of the present disclosure described below are not intended to be exhaustive or to limit the disclosure to the precise forms disclosed in the following detailed description. Rather, the embodiments are chosen and described so that others skilled in the art may appreciate and understand the principles and practices of the present disclosure.

The following embodiments and the accompanying drawings, which are incorporated into and form part of this disclosure, illustrate embodiments of the invention and together with the description, serve to explain the principles of the invention. To the accomplishment of the foregoing and related ends, certain illustrative aspects of the invention are described herein in connection with the following description and the annexed drawings. These aspects are indicative, however, of but a few of the various ways in which the principles of the invention can be employed and the subject invention is intended to include all such aspects and their equivalents. Other advantages and novel features of the invention will become apparent from the following detailed description of the invention when considered in conjunction with the drawings.

The secure parcel delivery locker and drone delivery system of the instant invention includes a physically secure weatherproof container formed from metal and/or polymers that are mechanically resistant to attack from physical assault by pry bars, screwdrivers, hammers, or any other tools. The parcel delivery locker would preferentially have a top lid, but any front or side door might suffice for human (non-drone) deliveries. Further, it would have an electronically controlled locking mechanism. The default condition in the event of a power failure would be a locked condition. A key backup would be included in case of power failure. Optionally, the parcel delivery locker may contain physical attachment devices for physical security against theft such as brackets for attachment to a residence or a walkway.

The parcel delivery locker differs from all others because it includes a plurality of other electronic enhancements. These features include at least one of the following features and preferably a plurality of them:
A motion detector
A heat sensor
Internet and/or cell phone connectivity
A video camera
Recording capability
An audio speaker and microphone
An electrically operated door opener/closer
Electronic lock activation
An audible alarm siren
A GPS tracking device
Transceiver for RF communications
An App to control the electronic features

Each of these electronic features are widely available separately and commercially but combining them into a secure parcel locker with exceptional “smart” electronic features is unique. For example, a preferred embodiment of the invention with multiple electronic enhancements would be a weatherproof metal or durable polymer parcel locker having enough internal capacity to accept a parcel delivery and having some physical attachment means to impede theft. Since the electronic enhancement features are not connected to the physical dimensions, they would work with any sized delivery locker. But, a parcel delivery locker with internal dimensions of 18 inches high by 24 inches wide by 18 inches deep would work well.

A further enhancement would be for the parcel delivery locker to have a cushioned inside bottom to reduce the risk to parcels delivered to it, e.g., from a hovering drone. Further, the parcel delivery locker may have internet and/or cell phone connectivity to its active electronic features. By means of an app, the parcel delivery locker would establish communication with the locker owner on a cell phone or keypad.

In the event of a human delivery, when motion and a human heat signature are detected by the sensors, the parcel delivery locker would alert the owner about the event. It would also activate not just the audio and video features, but also start recording everything. The video and audio records could be stored either locally or on the “cloud” or both.

The parcel delivery locker would be kept in an unlocked condition when empty, so active intervention would not be required from the delivery person. There is no reason to lock an empty locker. The delivery driver could open the unlocked parcel delivery locker manually and just deliver the parcel. Once the parcel delivery locker lid was closed, the parcel delivery locker would automatically activate the lock and other protective features.

In addition, the owner could communicate with the delivery driver if necessary, or remotely control the electronic lock after the delivery. After delivery of a parcel and locking of the lid, the parcel delivery locker would automatically arm additional theft deterrent systems such as an audible alarm siren and GPS tracking.

In the event of a drone delivery, drone deliveries can be made to local addresses by GPS coordinates, but they need more precise guidance to complete the local delivery. A delivery locker with precise radio navigation transmission capability and a drone so equipped would resolve this problem. The instant parcel delivery locker could have a low power radio transceiver that would generate a signal to allow the drone to locate exactly where to deliver the parcel. The signal could be at any frequency but might use commonly used frequencies like either a low frequency signal such as a Z-wave at 908.42 MHz or a high frequency signal such as a BLUETOOTH Low Energy (BLE) frequency signal at 2,400-2.483.5 MHz. It could constantly be turned on since it would be low power or activated when a drone was detected. The signal would contain three dimensional coordinates that could be detected on a drone equipped with compatible detection equipment such as a Geomagnetic Orientation Sensor that detects location information such as x, y, and z coordinates and the distances to the radio transmitter. The x coordinate would be distance from the transmitter, the y coordinate would be deviation left or right from the transmitter, and the z coordinate would be distance above the transmitter. These coordinates would allow a flight controller on the drone to navigate to the delivery spot (where the deviation from the x and y coordinates are zero). The drone might be pre-programmed for the z coordinate to be about three feet above the transmitter to allow for space to deliver the parcel.

Should a theft attempt be detected, the parcel delivery locker would activate the audible alarm, alert the locker owner, and activate the GPS tracker. It could also automatically contact a central monitoring station (if the locker owner is enrolled in such a service) to report the theft in process so that the theft could be reported to the police. The parcel delivery locker could also broadcast a pre-recorded announcement to the thief warning them that they were being recorded, that the audible alarm would start, that police had been notified, and that there is a GPS tracker in the locker.

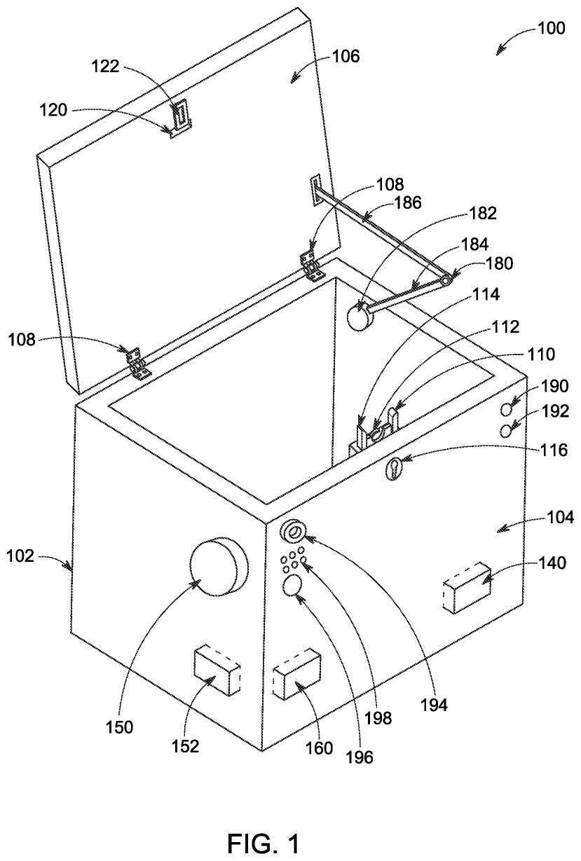

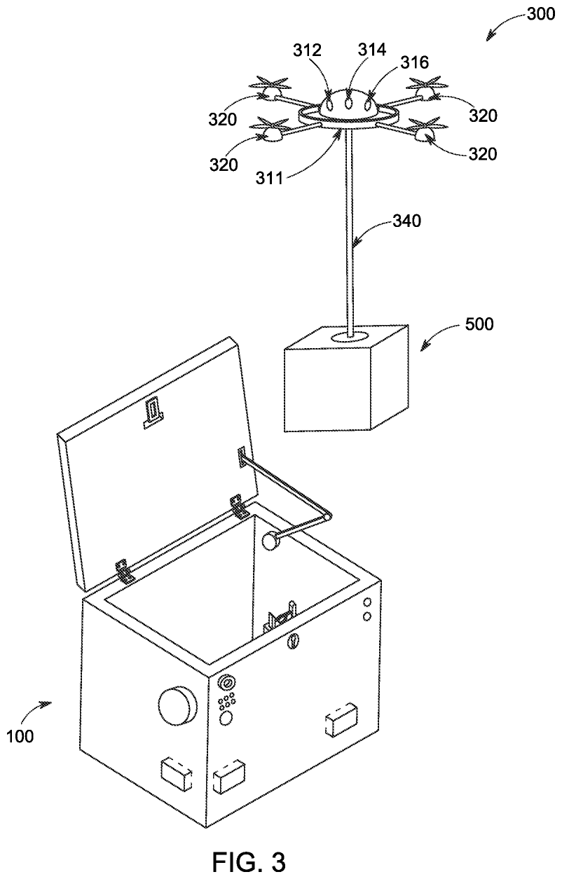

Turning now descriptively to the drawings, referring to FIGS. 1-3, the preferred embodiment of the secure parcel delivery locker 100 and drone delivery system 300 comprises a drone delivery system 300 including a drone 311 including a main body forming an interior volume, a lift and propulsion system 320 attached to the main body and adapted to transport the drone to predetermined locations; a package retention and delivery mechanism 340 adapted to releasably attach to, carry, and release packages 500 at chosen locations; a computer processor 312 located within the interior volume of the main body, wherein the computer processor includes computer programs thereon adapted to control the lift and propulsion system, a directional guidance system, and the package retention and delivery mechanism; a transceiver 314 located within the interior volume of the main body, wherein the transceiver is electronically connected with the computer processor and adapted to electronically communicate therewith, and wherein the transceiver is adapted to send and receive electronic communications with external transmitters and transceivers; and a power source 316 located within the interior volume of the main body and is electrically connected to and adapted to provide electric power to the computer processor and the transceiver, wherein at least one of the computer programs of the computer processor is adapted to communicate with a transceiver of a chosen parcel delivery locker in order to obtain guidance information therefrom, including its geospatial position, and help guide it to its location for delivery; and a parcel delivery locker 100 comprising a main body 102 including a bottom wall, at least one side wall 104 attached to the bottom wall and extends upwardly therefrom, and a cover 106 pivotally attached to the at least one side wall and is adapted to securely and releasably enclose a space formed between the bottom wall, the at least one side wall, and the cover when in a closed configuration; a first locking mechanism 110 including a receiver 112 adapted to receive electronic communications from a transmitter, and a retractable engagement member 114 adapted to be engaged with and retracted from a second locking mechanism, wherein said first locking mechanism is attached to the at least one side wall; a second locking mechanism 120 including an engagement member 122 adapted to releasably retain the engagement member of the first locking mechanism, wherein the second locking mechanism is attached to the cover, and wherein the second locking mechanism is adapted to securely and releasable engage with the first locking mechanism to securely and releasable enclose the space when in the closed configuration; a computer processor 140 attached to the main body and including computer programs thereon, is electronically connected with the receiver of the first locking mechanism, and is adapted to control the retractable engagement member thereof; a transceiver 150 attached to the main body, wherein the transceiver is electronically connected with the computer processor and adapted to electronically communicate therewith, and wherein the transceiver is adapted to send and receive electronic communications with external transmitters and transceivers; a power source 160 attached to the main body, wherein the power source is electrically connected to and adapted to provide electric power to the first locking mechanism, the computer processor, and the transceiver, wherein at least one of the computer programs of the computer processor is adapted to communicate with and control the drone of the drone delivery system and guide the drone to the geospatial position where the parcel delivery locker is located.

In the preferred embodiment, the cover 106 is pivotally attached to the at least one side wall via at least one hinge 108, and the power source 160 is a rechargeable battery.

In the preferred embodiment, an electric cover opener 180 is connected between the at least one side wall and the cover and includes an electro-mechanical motor 182 attached to the at least one side wall and is adapted to pivot a first mechanical arm, is electrically attached to the power source, and is electronically connected to and adapted to be controlled via the computer processor; a first mechanical arm 184 connected to the electro-mechanical motor and adapted to pivot with respect to the at least one side wall; and a second mechanical arm 186 pivotally connected between the first mechanical arm and the cover, wherein the electric cover opener is adapted to pivotally open and close the cover with respect to the at least one side wall.

In the preferred embodiment, the parcel delivery locker may further comprise a motion detector 190 attached to an outer surface of the main body, is electrically connected to the power source, and is electronically connected with the computer processor, and is adapted to detect motion in a chosen vicinity surrounding the parcel delivery locker and electronically send information to the computer processor for any of a variety of actions to be performed.

In the preferred embodiment, the parcel delivery locker may further comprise an infrared sensor 192 attached to an outer surface of the main body, is electrically connected to the power source, and is electronically connected with the computer processor, and is adapted to detect infrared signatures in a chosen vicinity surrounding the parcel delivery locker and electronically send information to the computer processor for any of a variety of actions to be performed.

In the preferred embodiment, the parcel delivery locker may further comprise a camera 194 attached to an outer surface of the main body, is electrically connected to the power source, and is electronically connected with the computer processor, and is adapted to visually scan a chosen vicinity surrounding the parcel delivery locker and electronically send information to the computer processor for any of a variety of actions to be performed.

In the preferred embodiment, the parcel delivery locker may further comprise a microphone 196 and a speaker 198 attached to an outer surface of the main body, are electrically connected to the power source, and are electronically connected with the computer processor; and are adapted to retrieve and send audio sounds within a chosen vicinity surrounding the parcel delivery locker and electronically send information to the computer processor for any of a variety of actions to be performed.

In the preferred embodiment, the parcel delivery locker may further comprise a GPS tracker 152 attached to the main body, is electrically connected to the power source, is electronically connected with the computer processor, and is adapted to retrieve and send GPS information to the computer processor for any of a variety of actions to be performed, including sending location information of the parcel delivery locker to a monitoring service or the authorities in the event the locker is stolen and to aid authorities in locating the parcel delivery locker.

In the preferred embodiment, the first locking mechanism 110 may further include a mechanical key lock mechanism 116 adapted to unlock the second locking mechanism from the first locking mechanism when needed or desired.

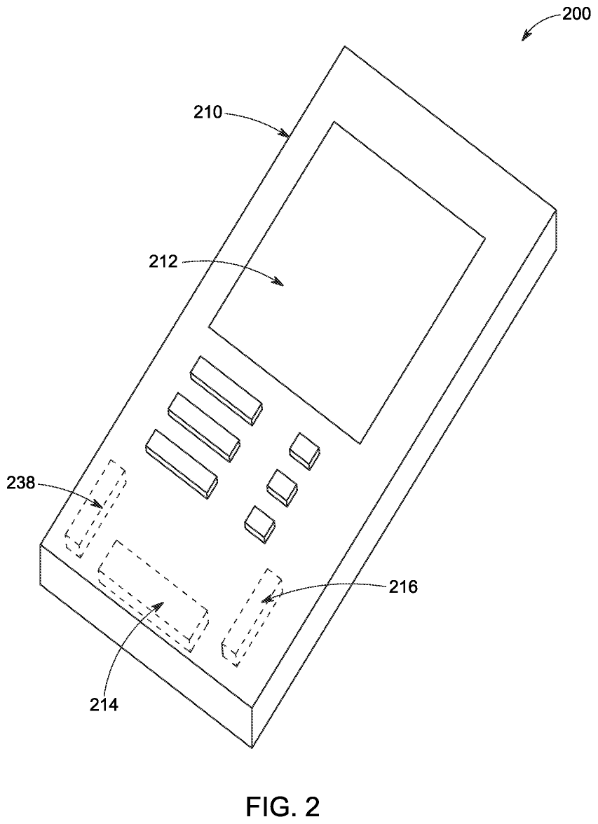

In the preferred embodiment, and as shown in FIG. 2, the parcel delivery locker may further comprise a control unit 200, which can be formed as a hand-held smart device, including a main body 210 forming an interior volume; a computer screen 212 located on an external surface of the main body; a computer processor 214 located within the interior volume of the main body, wherein the computer processor includes computer programs thereon adapted to communicate with and control the parcel delivery locker and the drone delivery system; a transceiver 216 located within the interior volume of the main body, is electronically connected with the computer processor and is adapted to electronically communicate therewith, and wherein the transceiver is adapted to send and receive electronic communications with the transceivers of the parcel delivery locker and the drone delivery system; and a power source 218 located within the interior volume of the main body and electrically connected to and adapted to provide electric power to the computer processor and the transceiver, wherein at least one of the computer programs of the computer processor is adapted to communicate with transceivers of a chosen parcel delivery locker and a chosen drone delivery system in order to control the parcel delivery locker and the chosen drone delivery system in order to guide the drone of the drone delivery system to the chosen parcel delivery locker, and wherein the control unit is adapted to perform functions chosen from a list of functions consisting of opening and closing the parcel delivery locker; locking and unlocking the parcel delivery locker; having said parcel delivery locker emit a siren; controlling a GPS tracker; calling 911; and operating a drone direction finder; and wherein the computer screen is adapted to display information of the control unit, the parcel delivery locker, and the drone delivery system thereon.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention.

Although the invention has been explained in relation to its preferred embodiment, it is to be understood that many other possible modifications and variations can be made without departing from the spirit and scope of the invention.

What is claimed is:

1. A parcel delivery locker for use with a drone delivery system, comprising:
a main body including:
a bottom wall;
at least one side wall;
wherein said at least one side wall is attached to said bottom wall and extends upwardly therefrom; and
a cover;
wherein said cover is pivotally attached to said at least one side wall and is adapted to securely and releasably enclose a space formed between said bottom wall, said at least one side wall, and said cover when in a closed configuration;
a first locking mechanism including:
a receiver;
wherein said receiver is adapted to receive electronic communications from a transmitter; and
a retractable engagement member;
wherein said retractable engagement member is adapted to be engaged with and retracted from a second locking mechanism;
wherein said first locking mechanism is attached to said at least one side wall;
said second locking mechanism including:
an engagement member;
wherein said engagement member is adapted to releasably retain said engagement member of said first locking mechanism;
wherein said second locking mechanism is attached to said cover; and
wherein said second locking mechanism is adapted to securely and releasable engage with said first locking mechanism to securely and releasable enclose said space when in said closed configuration;
a computer processor;
wherein said computer processor is attached to said main body;
wherein said computer processor includes computer programs thereon;
and wherein said computer processor is electronically connected with said receiver of said first locking mechanism, and is adapted to control said retractable engagement member thereof;
a transceiver:
wherein said transceiver is attached to said main body;
wherein said transceiver is electronically connected with said computer processor and adapted to electronically communicate therewith; and
wherein said transceiver is adapted to send and receive electronic communications with external transmitters and transceivers;
a power source:
wherein said power source is attached to said main body; and
wherein said power source is electrically connected to and adapted to provide electric power to said first locking mechanism, said computer processor, and said transceiver;
wherein at least one of said computer programs of said computer processor is adapted to communicate with and control a drone of a drone delivery system and guide said drone to the geographical position where said parcel delivery locker is located and position it in the proper geospatial spot to facilitate the parcel delivery.

2. The parcel delivery locker of claim 1, wherein said cover is pivotally attached to said at least one side wall via at least one hinge.

3. The parcel delivery locker of claim 1, wherein said power source is a rechargeable battery.

4. The parcel delivery locker of claim 1, further comprising an electric cover opener connected between said at least one side wall and said cover, and including:
an electro-mechanical motor;
wherein said electro-mechanical motor is attached to said at least one side wall and is adapted to pivot a first mechanical arm; and
wherein said electro-mechanical motor is electrically attached to said power source; and
wherein said electro-mechanical motor is electronically connected to and adapted to be controlled via said computer processor;
said first mechanical arm;
wherein said first mechanical arm is connected to said electro-mechanical motor and adapted to pivot with respect to said at least one side wall; and
a second mechanical arm;
wherein said second mechanical arm is pivotally connected between said first mechanical arm and said cover;
wherein said electric cover opener is adapted to pivotally open and close said cover with respect to said at least one side wall.

5. The parcel delivery locker of claim 1, further comprising a motion detector;
wherein said motion detector is attached to an outer surface of said main body, is electrically connected to said power source, and is electronically connected with said computer processor; and
wherein said motion detector is adapted to detect motion in a chosen vicinity surrounding said parcel delivery locker and electronically send motion detection information to said computer processor for any of a variety of actions to be performed.

6. The parcel delivery locker of claim 1, further comprising an infrared sensor;
wherein said infrared sensor is attached to an outer surface of said main body, is electrically connected to said power source, and is electronically connected with said computer processor; and
wherein said infrared sensor is adapted to detect infrared signatures in a chosen vicinity surrounding said parcel delivery locker and electronically send information to said computer processor for any of a variety of actions to be performed.

7. The parcel delivery locker of claim 1, further comprising a camera;
wherein said camera is attached to an outer surface of said main body, is electrically connected to said power source, and is electronically connected with said computer processor; and
wherein said camera is adapted to visually scan a chosen vicinity surrounding said parcel delivery locker and electronically send information to said computer processor for any of a variety of actions to be performed.

8. The parcel delivery locker of claim 1, further comprising a microphone and a speaker;
wherein said microphone and speaker are attached to an outer surface of said main body, are electrically connected to said power source, and are electronically connected with said computer processor; and
wherein said microphone and speaker are adapted to retrieve and send audio sounds within a chosen vicinity surrounding said parcel delivery locker and electronically send information to said computer processor for any of a variety of actions to be performed.

9. The parcel delivery locker of claim 1, further comprising a GPS tracker;
wherein said GPS tracker is attached to said main body, is electrically connected to said power source, and is electronically connected with said computer processor; and
wherein said GPS tracker is adapted to retrieve and send GPS information to said computer processor for any of a variety of actions to be performed, including sending location information of said parcel delivery locker to a monitoring station or the authorities to thereby aid in locating said parcel delivery locker in the event of theft.

10. The parcel delivery locker of claim 1, further comprising a control unit including:
a main body:
wherein said main body forms an interior volume;
a computer screen;
wherein said computer screen is located on an external surface of said main body;
a computer processor;
wherein said computer processor is located within said interior volume of said main body;
wherein said computer processor includes computer programs thereon adapted to communicate with and control said parcel delivery locker and said drone delivery system;
a transceiver:
wherein said transceiver is located within said interior volume of said main body;
wherein said transceiver is electronically connected with said computer processor and adapted to electronically communicate therewith; and
wherein said transceiver is adapted to send and receive electronic communications with said transceivers of said parcel delivery locker and said drone delivery system; and
a power source:
wherein said power source is located within said interior volume of said main body; and
wherein said power source is electrically connected to and adapted to provide electric power to said computer processor and said transceiver;
wherein at least one of said computer programs of said computer processor is adapted to communicate with transceivers of said parcel delivery locker and a chosen drone delivery system in order to control said parcel delivery locker and said chosen drone delivery system in order to guide a drone of said drone delivery system to said chosen parcel delivery locker;
wherein said control unit is adapted to perform functions chosen from a list of functions consisting of:
open and close said parcel delivery locker;
lock and unlock said parcel delivery locker;
have said parcel delivery locker emit a siren;
control a GPS tracker;
call 911; and
operate a drone direction finder; and
wherein said computer screen is adapted to display information of said control unit, said parcel delivery locker, and said drone delivery system thereon.

11. A combination of a parcel delivery locker and a drone delivery system comprising:
a drone delivery system including:
a drone including:
a main body;
wherein said body forms an interior volume;
a lift and propulsion system;
wherein said lift and propulsion system attached to said main body and adapted to transport said drone to predetermined locations;
a package retention and delivery mechanism;
wherein said package retention and delivery mechanism is adapted to releasably attach to, carry, and release packages at chosen locations;
a computer processor;
wherein said computer processor is located within said interior volume of said main body;
wherein said computer processor includes computer programs thereon adapted to control said lift and propulsion system, said package retention and delivery mechanism, and a directional guidance system;
a transceiver:
wherein said transceiver is located within said interior volume of said main body;
wherein said transceiver is electronically connected with said computer processor and adapted to electronically communicate therewith; and
wherein said transceiver is adapted to send and receive electronic communications with external transmitters and transceivers; and
a power source:
wherein said power source is located within said interior volume of said main body; and
wherein said power source is electrically connected to and adapted to provide electric power to said computer processor and said transceiver;
wherein at least one of said computer programs of said computer processor is adapted to communicate with a transceiver of a chosen parcel delivery locker in order to obtain guidance information therefrom, including its geospatial position, and help guide it to its location for delivery; and
a parcel delivery locker comprising:
a main body including:
a bottom wall;
at least one side wall;
wherein said at least one side wall is attached to said bottom wall and extends upwardly therefrom; and
a cover;
wherein said cover is pivotally attached to said at least one side wall and is adapted to securely and releasably enclose a space formed between said bottom wall, said at least one side wall, and said cover when in a closed configuration;
a first locking mechanism including:
a receiver;
wherein said receiver is adapted to receive electronic communications from a transmitter; and
a retractable engagement member;
wherein said retractable engagement member is adapted to be engaged with and retracted from a second locking mechanism;
wherein said first locking mechanism is attached to said at least one side wall;
said second locking mechanism including:
an engagement member;
wherein said engagement member is adapted to releasably retain said engagement member of said first locking mechanism;
wherein said second locking mechanism is attached to said cover; and
wherein said second locking mechanism is adapted to securely and releasable engage with said first locking mechanism to securely and releasable enclose said space when in said closed configuration;
a computer processor;
wherein said computer processor is attached to said main body;
wherein said computer processor includes computer programs thereon;
and wherein said computer processor is electronically connected with said receiver of said first locking mechanism, and is adapted to control said retractable engagement member thereof;
a transceiver:
wherein said transceiver is attached to said main body;
wherein said transceiver is electronically connected with said computer processor and adapted to electronically communicate therewith; and
wherein said transceiver is adapted to send and receive electronic communications with external transmitters and transceivers;
a power source:
wherein said power source is attached to said main body; and
wherein said power source is electrically connected to and adapted to provide electric power to said first locking mechanism, said computer processor, and said transceiver;
wherein at least one of said computer programs of said computer processor is adapted to communicate with and control said drone of said drone delivery system and guide said drone to the geographical position where said parcel delivery locker is located and position it in the proper geospatial spot to facilitate the parcel delivery.

12. The combination of claim 11, wherein said cover is pivotally attached to said at least one side wall via at least one hinge.

13. The combination of claim 11, wherein said power source is a rechargeable battery.

14. The combination of claim 11, further comprising an electric cover opener connected between said at least one side wall and said cover, and including:
an electro-mechanical motor;
wherein said electro-mechanical motor is attached to said at least one side wall and is adapted to pivot a first mechanical arm; and
wherein said electro-mechanical motor is electrically attached to said power source; and
wherein said electro-mechanical motor is electronically connected to and adapted to be controlled via said computer processor;
said first mechanical arm;
wherein said first mechanical arm is connected to said electro-mechanical motor and adapted to pivot with respect to said at least one side wall; and
a second mechanical arm;
wherein said second mechanical arm is pivotally connected between said first mechanical arm and said cover;
wherein said electric cover opener is adapted to pivotally open and close said cover with respect to said at least one side wall.

15. The combination of claim 11, further comprising a motion detector;
wherein said motion detector is attached to an outer surface of said main body, is electrically connected to said power source, and is electronically connected with said computer processor; and
wherein said motion detector is adapted to detect motion in a chosen vicinity surrounding said parcel delivery locker and electronically send motion detection information to said computer processor for any of a variety of actions to be performed.

16. The combination of claim 11, further comprising an infrared sensor;
wherein said infrared sensor is attached to an outer surface of said main body, is electrically connected to said power source, and is electronically connected with said computer processor; and
wherein said infrared sensor is adapted to detect infrared signatures in a chosen vicinity surrounding said parcel delivery locker and electronically send information to said computer processor for any of a variety of actions to be performed.

17. The combination of claim 11, further comprising a camera;
wherein said camera is attached to an outer surface of said main body, is electrically connected to said power source, and is electronically connected with said computer processor; and
wherein said camera is adapted to visually scan a chosen vicinity surrounding said parcel delivery locker and electronically send information to said computer processor for any of a variety of actions to be performed.

18. The combination of claim 11, further comprising a microphone and a speaker;
wherein said microphone and speaker are attached to an outer surface of said main body, are electrically connected to said power source, and are electronically connected with said computer processor; and
wherein said microphone and speaker are adapted to retrieve and send audio sounds within a chosen vicinity surrounding said parcel delivery locker and electronically send information to said computer processor for any of a variety of actions to be performed.

19. The combination of claim 11, further comprising a GPS tracker;
wherein said GPS tracker is attached to said main body, is electrically connected to said power source, and is electronically connected with said computer processor; and
wherein said GPS tracker is adapted to retrieve and send GPS information to said computer processor for any of a variety of actions to be performed, including sending location information of said parcel delivery locker to a monitoring station or the authorities to thereby aid in locating said parcel delivery locker in the event of theft.

20. The combination of claim 11, further comprising a control unit including:
a main body:
wherein said main body forms an interior volume;
a computer screen;
wherein said computer screen is located on an external surface of said main body;
a computer processor;
wherein said computer processor is located within said interior volume of said main body;
wherein said computer processor includes computer programs thereon adapted to communicate with and control said parcel delivery locker and said drone delivery system;
a transceiver:
wherein said transceiver is located within said interior volume of said main body;
wherein said transceiver is electronically connected with said computer processor and adapted to electronically communicate therewith; and
wherein said transceiver is adapted to send and receive electronic communications with said transceivers of said parcel delivery locker and said drone delivery system; and
a power source:
wherein said power source is located within said interior volume of said main body; and
wherein said power source is electrically connected to and adapted to provide electric power to said computer processor and said transceiver;
wherein at least one of said computer programs of said computer processor is adapted to communicate with transceivers of a chosen parcel delivery locker and a chosen drone delivery system in order to control said parcel delivery locker and said chosen drone delivery system in order to guide said drone of said drone delivery system to said chosen parcel delivery locker and position it in the proper geospatial spot to facilitate the parcel delivery; and
wherein said control unit is adapted to perform functions chosen from a list of functions consisting of:
open and close said parcel delivery locker;
lock and unlock said parcel delivery locker;
have said parcel delivery locker emit a siren;
control a GPS tracker;
call 911; and
operate a drone direction finder; and
wherein said computer screen is adapted to display information of said control unit, said parcel delivery locker, and said drone delivery system thereon.
